(19) United States
(12) Patent Application Publication
(10) Pub. No.: US 2026/0111005 A1
(43) Pub. Date: Apr. 23, 2026

(54) SYSTEM AND METHOD FOR PLASMA PULSING SCHEME SELECTION AND OPTIMIZATION

(71) Applicant: Tokyo Electron Limited, Tokyo (JP)

(72) Inventors: Qiang Wang, Austin, TX (US); Shyam Sridhar, Austin, TX (US); Tsung-Cheng Lin, Austin, TX (US); Peter Lowell George Ventzek, Austin, TX (US); Mitsunori Ohata, Taiwa-cho (JP)

(21) Appl. No.: 19/262,974

(22) Filed: Jul. 8, 2025

Related U.S. Application Data
(60) Provisional application No. 63/711,119, filed on Oct. 23, 2024.

(51) Int. Cl. G05B 19/4099

(52) U.S. Cl. CPC G05B 19/4099; G05B 2219/45031

(57) ABSTRACT

A method includes determining process parameters of a plasma process based on a desired objective function and determining a pulsing scheme of the plasma process based on the desired objective function. The pulsing scheme includes a pulsing petameter matrix including timing and power-level parameters of a radio frequency (RF) source power supply and a bias power supply. The method includes sending the process parameters and the pulsing scheme to a plasma apparatus, introducing a substrate into a process chamber of the plasma apparatus, and performing the plasma process on the substrate using the process parameters and the pulsing scheme.

### CROSS-REFERENCE TO RELATED APPLICATIONS

This application claims the benefit of U.S. Provisional Application No. 63/711,119, filed on Oct. 23, 2024, which application is hereby incorporated herein by reference.

### TECHNICAL FIELD

The present disclosure relates generally to systems and methods for processing a substrate and, in particular embodiments, to a system and method for plasma pulsing scheme selection and optimization.

### BACKGROUND

Plasma processing systems have become fundamental tools in semiconductor fabrication for performing etching and deposition operations on substrates such as semiconductor wafers. These systems generate plasma by supplying high frequency electrical power to gas mixtures within a process chamber, ionizing the gases to create reactive species for material processing. Modern plasma processing equipment typically includes a process chamber housing a substrate support or chuck, gas delivery systems for introducing process gases, vacuum pumping systems for pressure control, and multiple power supplies for plasma generation and substrate biasing.

Plasma generation in these systems commonly employs radio frequency (RF) power sources operating. The RF power may be applied through various electrode configurations, including capacitively coupled plasma systems where power is applied between parallel electrodes, and inductively coupled plasma systems where power is applied through inductive coils. Substrate biasing represents another aspect of plasma processing control, where bias power supplies apply electrical potential to the substrate support, influencing the energy and directionality of ions striking the substrate surface.

### SUMMARY

In accordance with an embodiment, a method includes: determining process parameters of a plasma process based on a desired objective function; determining a pulsing scheme of the plasma process based on the desired objective function, where the pulsing scheme includes a pulsing petameter matrix including timing and power-level parameters of a radio frequency (RF) source power supply and a bias power supply; sending the process parameters and the pulsing scheme to a plasma apparatus; introducing a substrate into a process chamber of the plasma apparatus; and performing the plasma process on the substrate using the process parameters and the pulsing scheme.

In accordance with another embodiment, a system includes: a plasma apparatus configured to: receive a substrate in a process chamber; receive process parameters and a pulsing scheme for a plasma process from a controller; perform the plasma process on the substrate using the process parameters and the pulsing scheme; and the controller coupled to the plasma apparatus, where the controller is configured to: determine the process parameters of the plasma process based on a desired objective function; determine the pulsing scheme of the plasma process based on the desired objective function, where the pulsing scheme includes a pulsing petameter matrix including timing and power-level parameters of a radio frequency (RF) source power supply and a bias power supply; and send the process parameters and the pulsing scheme to the plasma apparatus.

In accordance with yet another embodiment, a controller includes: a non-transitory computer-readable memory configured to store instructions; one or more processors coupled to the non-transitory computer-readable memory, where the instructions, when executed by the one or more processors, cause the one or more processors to: determine process parameters of a plasma process based on a desired objective function; determine a pulsing scheme of the plasma process based on the desired objective function, where the pulsing scheme includes a pulsing petameter matrix including timing and power-level parameters of a radio frequency (RF) source power supply and a bias power supply; send the process parameters and the pulsing scheme to a plasma apparatus; send a first control signal to the plasma apparatus to introduce a substrate into a process chamber of the plasma apparatus; and send a second control signal to the plasma apparatus to perform the plasma process on the substrate using the process parameters and the pulsing scheme.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a schematic view of a plasma apparatus, in accordance with various embodiments;

FIG. 2A illustrates a pulsing scheme template and a corresponding pulsing parameter matrix, in accordance with various embodiments;

FIG. 2B illustrates a table showing pulsing parameter matrix values for the pulsing scheme template of FIG. 2A and corresponding pulsing schemes, in accordance with various embodiments;

FIG. 3A illustrates a pulsing scheme template and a corresponding pulsing parameter matrix, in accordance with various embodiments;

FIG. 3B illustrates a table showing pulsing parameter matrix values for the pulsing scheme template of FIG. 3A and corresponding pulsing schemes, in accordance with various embodiments;

FIG. 4 illustrates a pulsing scheme template and a corresponding pulsing parameter matrix, in accordance with various embodiments;

FIG. 5 illustrates a flow diagram of a substrate processing method, in accordance with various embodiments;

FIGS. 6A and 6B illustrate a flow diagram of a method for plasma process parameter optimization, in accordance with various embodiments;

FIGS. 7A and 7B illustrate a flow diagram of a method for pulsing scheme selection and optimization, in accordance with various embodiments;

FIG. 8A illustrates a graph showing a dependence of an objective function on iterations and corresponding pulsing schemes, in accordance with various embodiments;

FIG. 8B illustrates a table showing pulsing schemes and corresponding features formed by a plasma process using the pulsing schemes, in accordance with various embodiments;

FIG. 9 illustrates a graph showing a dependence of an objective function on iterations and corresponding pulsing schemes, in accordance with various embodiments; and

FIG. 10 is a block diagram of a computing system, in accordance with various embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

While various embodiments of the present disclosure are described primarily in the context of plasma etching processes for semiconductor fabrication, it should also be appreciated that these embodiments may also apply to plasma deposition processes, plasma surface modification processes, and other plasma-assisted manufacturing operations. In particular, various embodiments of the present disclosure may similarly apply to plasma enhanced chemical vapor deposition, plasma enhanced atomic layer deposition, plasma cleaning processes, and plasma treatment of various substrate materials including metals, ceramics, and polymeric materials.

Embodiments of the present disclosure provide techniques for automated plasma pulsing scheme selection and optimization in plasma processing systems. Process development in plasma processing often involves tuning multidimensional operating parameters, which can be extremely laborious and time-consuming. Pulsing designs add additional complexity and may require even more development time. Baseline recipes for process tuning are typically based on previous experiences which may be completely irrelevant to new processes being developed.

Embodiments of the present disclosure apply simulation-based modeling and advanced optimization algorithms to provide guidelines for process engineers in selecting and optimizing plasma pulsing schemes. The approach uses predefined pulsing scheme templates that can generate expected pulsing scheme shapes for different levels of complexity. For example, a first template can handle one RF source and one bias power supply. For another example, a second template can accommodate one RF source with two bias power supplies, enabling independent control of multiple bias frequencies. In some embodiments, a generalized template that supports multiple pulsing periods for more complex applications may be used.

In some embodiments, the optimization process integrates plasma/sheath modeling with feature modeling (e.g., surface/profile modeling) to calculate ion and radical fluxes, energy distributions, and resulting process features. Bayesian optimization combined with machine learning (ML) techniques iteratively updates parameter values until convergence criteria are met. In some embodiments, the system first optimizes general process parameters such as pressure, flow rates, and power levels under continuous wave conditions. If the objective function remains above a threshold value, the system proceeds to optimize pulsing scheme parameters using the predefined templates, starting with simpler configurations and progressing to more complex configurations as needed.

In various embodiments, the template-based design enables systematic exploration of pulsing parameter space while maintaining computational efficiency through limited parameter sets. The integration of physics-based modeling with advanced optimization algorithms achieves reliable calculations and provides practical insights for real applications. The automated approach reduces development time compared to experimental trial-and-error methods, while the simulation-driven optimization can operate initially without extensive experimental data. These and additional details are further discussed below.

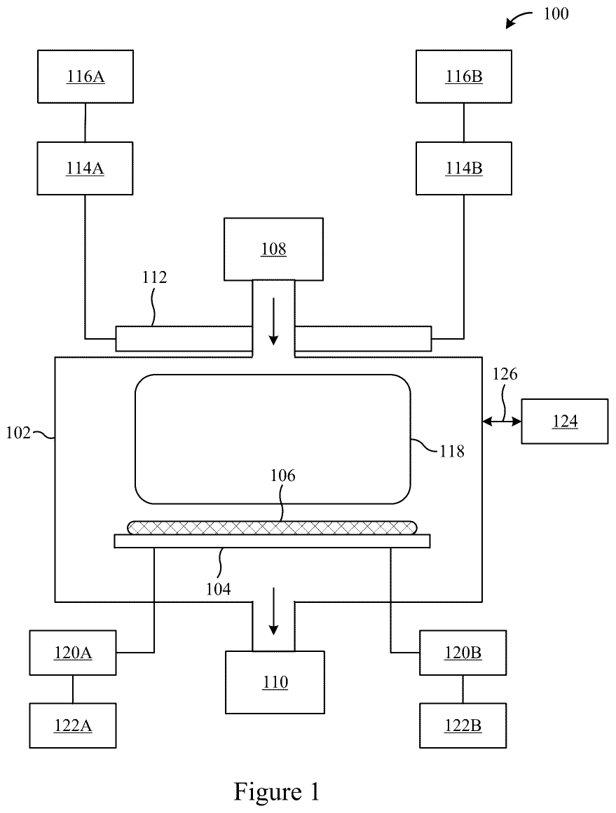

FIG. 1 is a schematic view of a plasma apparatus 100, in accordance with various embodiments. In various embodiments, the plasma apparatus 100 may be configured as a capacitively coupled plasma system, an inductively coupled plasma system, a hybrid configuration combining multiple plasma generation mechanisms, or the like.

In some embodiments, the plasma apparatus 100 includes a process chamber 102 that houses the plasma processing environment and maintains the controlled atmosphere for substrate processing. The process chamber 102 may comprise materials such as aluminum, stainless steel, or anodized aluminum to provide chemical resistance and structural integrity. In an embodiment, the process chamber 102 includes temperature control systems (not shown) such as heating elements or cooling channels to maintain chamber walls at desired temperatures. The process chamber 102 may also include view ports, access ports for diagnostic equipment, and interfaces for various sensors to monitor process conditions.

A chuck 104 is positioned within the process chamber 102 and configured to support a substrate 106 during processing operations. In some embodiments, the chuck 104 may include electrostatic clamping mechanisms utilizing Coulomb or Johnsen-Rahbek forces to secure the substrate 106 without mechanical clamping. In other embodiments, the chuck 104 may comprise a mechanical chuck using mechanical clamping to secure the substrate 106 or a vacuum chuck using pressure difference to secure the substrate 106. In various embodiments, the chuck 104 may incorporate temperature control capabilities through embedded heating elements, cooling channels, or thermoelectric devices to maintain the substrate 106 at desired temperatures. The chuck 104 may also include gas delivery channels for backside cooling, and lift pin mechanisms for substrate transfer operations.

In some embodiments, the substrate 106 may include MEMS devices, semiconductor devices, or semiconductor structures and may be formed in any suitable manner, including using any suitable combination of wet and/or dry deposition and etch techniques. The substrate 106 may comprise layers of semiconductors suitable for various microelectronics. In one or more embodiments, the substrate 106 may comprise a silicon wafer. In certain embodiments, the substrate 106 may comprise a silicon germanium wafer, silicon carbide wafer, gallium arsenide wafer, gallium nitride wafer, or other compound semiconductors. In other embodiments, the substrate 106 may comprise heterogeneous layers such as silicon germanium on silicon, gallium nitride on silicon, silicon carbon on silicon, or layers of silicon on a silicon or SOI substrate. In other embodiments, the substrate 106 may comprise a dielectric material, a glass, or the like.

In some embodiments, the substrate 106 may comprise a target layer. For example, the target layer may be patterned by a plasma etch process performed by the plasma apparatus 100. The target layer may include dielectric materials, semiconductor materials, conductive materials, or combinations thereof, depending on the specific device structures being fabricated. In some embodiments, the target layer may comprise materials such as silicon, silicon oxynitride, organic materials, non-organic materials, or amorphous carbon. In an embodiment, the target layer may be a silicon bottom anti-reflective coating (Si-BARC), which can enhance the precision of subsequent patterning steps. The target layer may also serve as a mask layer, comprising either a single hard mask or a stacked hard mask. In the case of a stacked hard mask, it may include two or more layers of different materials. For example, in a two-layer configuration, the first layer may comprise a metal-based material such as titanium nitride, titanium, tantalum nitride, tantalum, tungsten-based compounds, ruthenium-based compounds, aluminum-based compounds, combinations thereof, or the like. The second layer may comprise a dielectric layer composed of materials such as silicon dioxide, silicon nitride, silicon oxynitride, silicon carbide, amorphous silicon, polycrystalline silicon, combinations thereof, or the like.

The deposition of the target layer may be achieved through various suitable processes. In some embodiments, the target layer be deposited using spin-on coating techniques, chemical vapor deposition (CVD), atomic layer deposition (ALD), plasma-enhanced CVD (PECVD), plasma-enhanced ALD (PEALD), a combination thereof, or the like.

A gas system 108 is coupled to the process chamber 102 and configured to introduce process gases into the process chamber 102. The gas system 108 may include multiple gas sources depending on specific processing requirements. In an embodiment, the gas system 108 includes mass flow controllers, pressure regulators, and mixing manifolds to provide control over gas composition and flow rates. The gas delivery may occur through showerhead distributors, side injection ports, or other configurations designed to achieve uniform gas distribution across the substrate surface.

One or more pumps 110 are coupled to the process chamber 102 to maintain desired pressure levels and remove reaction byproducts during processing. The pumps 110 may include turbomolecular pumps, mechanical roughing pumps, cryogenic pumps, combinations thereof, or the like. The one or more pumps 110 may be configured with appropriate gas handling capabilities for the specific chemistry being used, including corrosion-resistant materials and specialized exhaust treatment systems.

In the illustrated embodiment, the plasma apparatus 100 further comprises an electrode 112 to facilitate plasma generation within the process chamber 102 and may serve dual functions as both a plasma generation element and a gas distribution component. In an embodiment, the electrode 112 may be configured as a showerhead electrode with multiple gas injection holes to provide uniform gas distribution while serving as an RF electrode.

Radio frequency source power supplies 116A and 116B are coupled to the electrode 112 through respective matching circuits 114A and 114B to provide the electrical energy for plasma generation. The RF source power supplies 116A and 116B may operate at frequencies in a range from 1 MHz to 100 MHz, and may provide power levels in a range from 1 W to 10 kW. The matching circuits 114A and 114B provide impedance matching between the RF source power supplies 116A and 116B and the plasma load to maximize power transfer efficiency and may include capacitors, inductors, and control systems for automatic impedance matching during processing.

Bias power supplies 122A and 122B are coupled to the chuck 104 through respective matching circuits 120A and 120B to enable independent control of substrate biasing. The bias power supplies 122A and 122B influence ion energy and directionality at the substrate surface and may operate at frequencies ranging from direct current to several megahertz. In an embodiment, bias power supply 122A operates at a frequency of 13.56 MHz, while bias power supply 122B provides direct current or low frequency bias in the kilohertz range (e.g., 400 kHz). The matching circuits 120A and 120B may include specialized components for handling the impedance characteristics of the substrate 106 and the chuck 104. In various embodiments, the bias power supplies 122A and 122B support synchronized or asynchronous pulsing operations with timing control relative to the RF source power supplies 116A and 116B.

The plasma 118 is generated within the process chamber 102 through the application of RF power from the RF source power supplies 116A and/or 116B, creating reactive species for processing the substrate 106. In an embodiment, density and uniformity of the plasma 118 across the substrate surface can be controlled through the relative power levels and pulsing schemes applied to the multiple power supplies (e.g., RF source power supplies 116A and 116B, and the bias power supplies 122A and 122B). The plasma 118 characteristics may be monitored through optical emission spectroscopy, or other diagnostic techniques to provide feedback for process control and optimization.

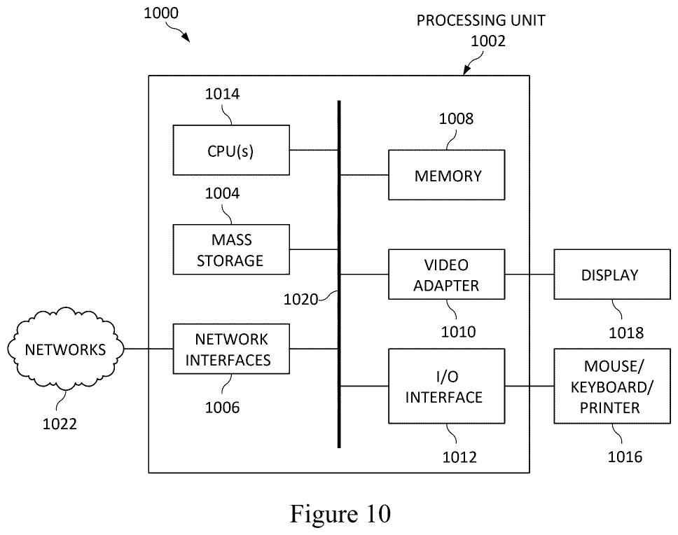

A controller 124 is coupled to the plasma apparatus 100 and configured to implement the optimized plasma pulsing schemes determined through the methods described herein. In the illustrated embodiment, the controller 124 is a part of the plasma apparatus 100. In other embodiments, the controller 124 may be external to the plasma apparatus 100. The controller 124 may include processing capabilities for executing optimization algorithms, memory for storing pulsing parameter matrices and process data, and communication interfaces for coordinating with the various subsystems of the plasma apparatus 100. In an embodiment, the controller 124 performs a method for plasma pulsing scheme selection and optimization. The controller 124 may include one or more processors, non-transitory computer-readable memory, and specialized hardware for real-time control of plasma processing operations. In some embodiments, the controller 124 may implemented by a computing system 1000 described below with reference to FIG. 10.

In some embodiments, the controller 124 generates control signals 126 that are transmitted to the various components of the plasma apparatus 100 to implement the optimized pulsing schemes and process parameters. The control signals 126 include timing and power level commands for the radio frequency source power supplies 116A and 116B, as well as the bias power supplies 122A and 122B. In various embodiments, the control signals 126 provide temporal control over power modulation according to the pulsing parameter matrices determined through the optimization process. The control signals 126 may also include commands for the gas system 108, pumps 110, temperature control systems, and other process control equipment to maintain optimal processing conditions. In an embodiment, the control signals 126 enable synchronized or asynchronous operation of multiple power supplies to achieve the complex pulsing schemes that optimize plasma processing outcomes.

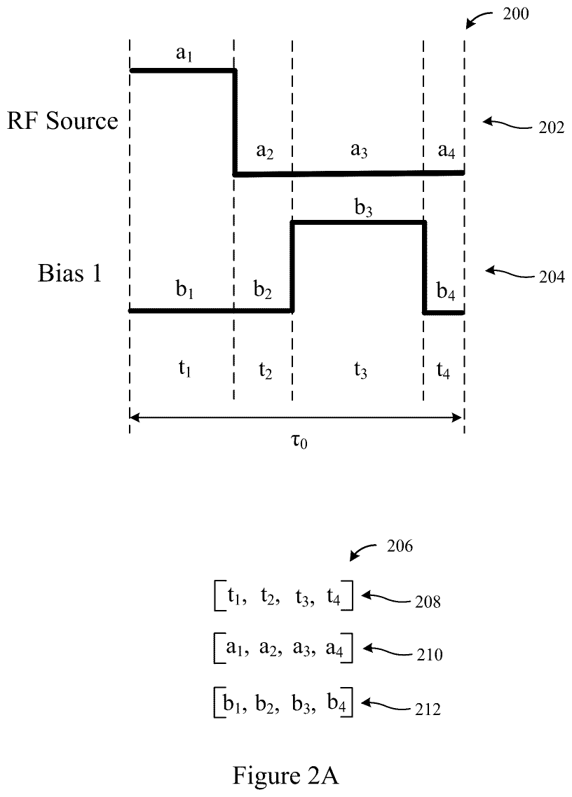

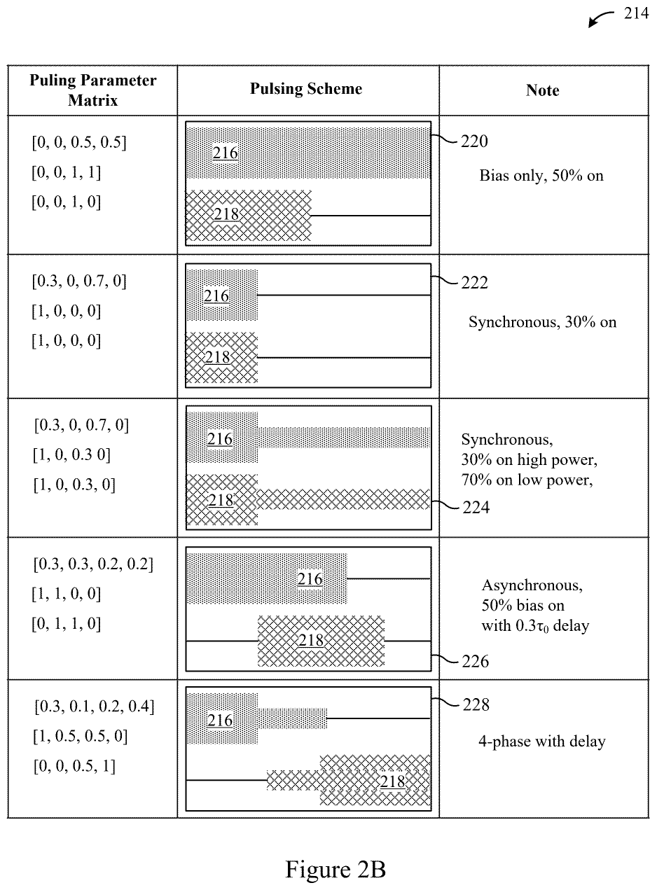

FIG. 2A illustrates a pulsing scheme template 200 and a corresponding pulsing parameter matrix 206, in accordance with various embodiments. The pulsing scheme template 200 provides a systematic framework for defining and optimizing plasma pulsing operations with controlled timing and power level parameters. In an embodiment, the pulsing scheme template 200 enables representation of complex pulsing sequences through a limited set of parameters that can be efficiently optimized using ML and Bayesian optimization techniques.

The pulsing scheme template 200 includes timing diagrams 202 and 204 that illustrate the temporal behavior of the RF source power and the bias power respectively during a pulsing period τ₀. The timing diagram 202 shows the RF source power modulation with the RF source power levels a₁, a₂, a₃, and a₄ corresponding to time segments t₁, t₂, t₃, and t₄ that collectively span the pulsing period τ₀. In various embodiments, the time segments t₁, t₂, t₃, and t₄ are normalized values between 0 and 1, where the sum of all time segments equals 1, representing the pulsing period τ₀, and the RF source power levels a₁, a₂, a₃, and a₄ are normalized values between 0 and 1, where 0 represents no power output and 1 represents full power output.

The timing diagram 204 shows the bias power modulation with the bias power levels b₁, b₂, b₃, and b₄ corresponding to the time segments t₁, t₂, t₃, and t₄. In various embodiments, the bias power levels b₁, b₂, b₃, and b₄ are normalized values between 0 and 1, where 0 represents no power output and 1 represents full power output. In some embodiments, the pulsing scheme template 200 enables synchronized or asynchronous operation between the RF source and bias power supplies. In an embodiment, the pulsing period τ₀ may be in a range from 1 μs to 1000 ms depending on the specific processing requirements and hardware capabilities of the plasma apparatus 100.

The pulsing parameter matrix 206 comprises arrays 208, 210, and 212 that define the pulsing scheme through timing and power level parameters. The array 208 comprises the timing parameters [t₁, t₂, t₃, t₄], the array 210 comprises the RF source power level parameters [a₁, a₂, a₃, a₄], and the array 212 comprises the bias power level parameters [b₁, b₂, b₃, b₄]. The power level parameters in the arrays 210 and 212 may represent different types of power modulation including amplitude modulation, duty cycle modulation, or frequency modulation depending on the specific power supply characteristics and processing requirements.

The pulsing scheme template 200 enables generation of various pulsing schemes including bias-only operation, source-only operation, synchronous pulsing, and asynchronous pulsing with controlled phase relationships. In various embodiments, the optimization process iteratively adjusts the values in the pulsing parameter matrix 206 to minimize objective functions related to process performance metrics such as etch rate uniformity, selectivity, feature uniformity, critical dimension control, or the like.

FIG. 2B illustrates a table 214 showing pulsing parameter matrix values for the pulsing scheme template 200 of FIG. 2A and corresponding pulsing schemes, in accordance with various embodiments. The table 214 demonstrates the practical application of the pulsing parameter matrix 206 by providing specific numerical values that generate distinct pulsing behaviors.

The first row of the table 214 illustrates a bias-only pulsing scheme with the continuous RF source power using the pulsing parameter matrix comprising the array [0, 0, 0.5, 0.5] for timing, the array [0, 0, 1, 1] for the RF source power, and the array [0, 0, 1, 0] for the bias power. In this configuration, the RF source power remains at full power throughout the entire pulsing period, while the bias power operates at 50% duty cycle. A pulsing scheme 220 shows waveforms 216 and 218 illustrating the temporal behavior, where the waveform 216 represents the RF source power remaining at full power and the waveform 218 represents the bias power switching between on and off states.

The second row of the table 214 illustrates synchronous pulsing with 30% duty cycle using the pulsing parameter matrix comprising the array [0.3, 0, 0.7, 0] for timing, the array [1, 0, 0, 0] for the RF source power, and the array [1, 0, 0, 0] for the bias power. In various embodiments, this configuration produces simultaneous switching of both the RF source and bias power supplies, where both powers are on for 30% of the pulsing period and off for the remaining 70%. A pulsing scheme 222 shows waveforms 216 and 218 illustrating the temporal behavior, where the waveform 216 represents the RF source power switching between on and off states and the waveform 218 represents the bias power switching between on and off states. The synchronous operation enables coordinated control of plasma generation and ion energy, which can be beneficial for certain etching or deposition processes.

The third row of the table 214 illustrates synchronous pulsing with high-low power operation using the pulsing parameter matrix comprising the array [0.3, 0, 0.7, 0] for timing, the array [1, 0, 0.3, 0] for the RF source power, and the array [1, 0, 0.3, 0] for the bias power. In this configuration, both the RF source and bias power operate at full power for 30% of the pulsing period, then switch to 30% power level for the remaining 70% of the pulsing period. A pulsing scheme 224 shows waveforms 216 and 218 illustrating the temporal behavior, where the waveform 216 represents the RF source power switching between high and low power states and the waveform 218 represents the bias power switching between high and low power states. In an embodiment, the multi-level power operation can provide enhanced process control by enabling different plasma conditions during different phases of the pulsing cycle.

The fourth row of the table 214 illustrates asynchronous pulsing with a phase delay using the pulsing parameter matrix comprising the array [0.3, 0.3, 0.2, 0.2] for timing, the array [1, 1, 0, 0] for the RF source power, and the array [0, 1, 1, 0] for the bias power. This configuration creates a phase-shifted relationship between the RF source and bias powers, where the bias power is delayed by 0.3τ₀ relative to the RF source power and operates at 50% duty cycle. A pulsing scheme 226 shows waveforms 216 and 218 illustrating the temporal behavior, where the waveform 216 represents the RF source power switching between on and off states and the waveform 218 represents the bias power switching between on and off states. The asynchronous operation enables independent control of plasma generation and substrate biasing, which can be advantageous for processes benefiting from decoupled control of plasma density and ion energy.

The fifth row of the table 214 illustrates a four-phase pulsing scheme using the pulsing parameter matrix comprising the array [0.3, 0.1, 0.2, 0.4] for timing, the array [1, 0.5, 0.5, 0] for the RF source power, and the array [0, 0, 0.5, 1] for the bias power. A pulsing scheme 228 shows waveforms 216 and 218 illustrating the temporal behavior, where the waveform 216 represents the RF source power switching between high, low and off states, and the waveform 218 represents the bias power switching between high, low and off states. In some embodiments, the four-phase operation provides multiple degrees of freedom for process optimization while maintaining computational tractability through the limited parameter set defined by the pulsing scheme template 200 (see FIG. 2A).

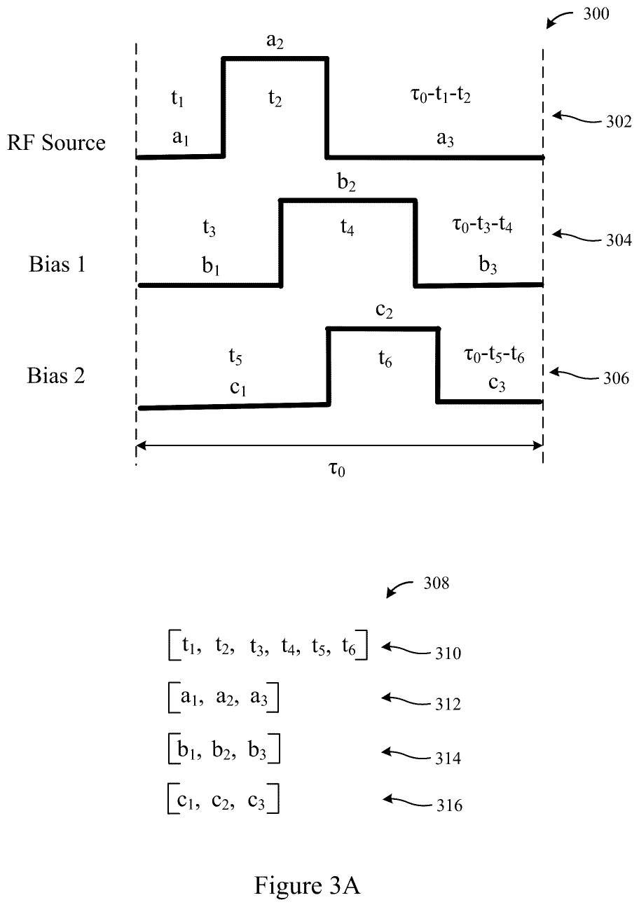

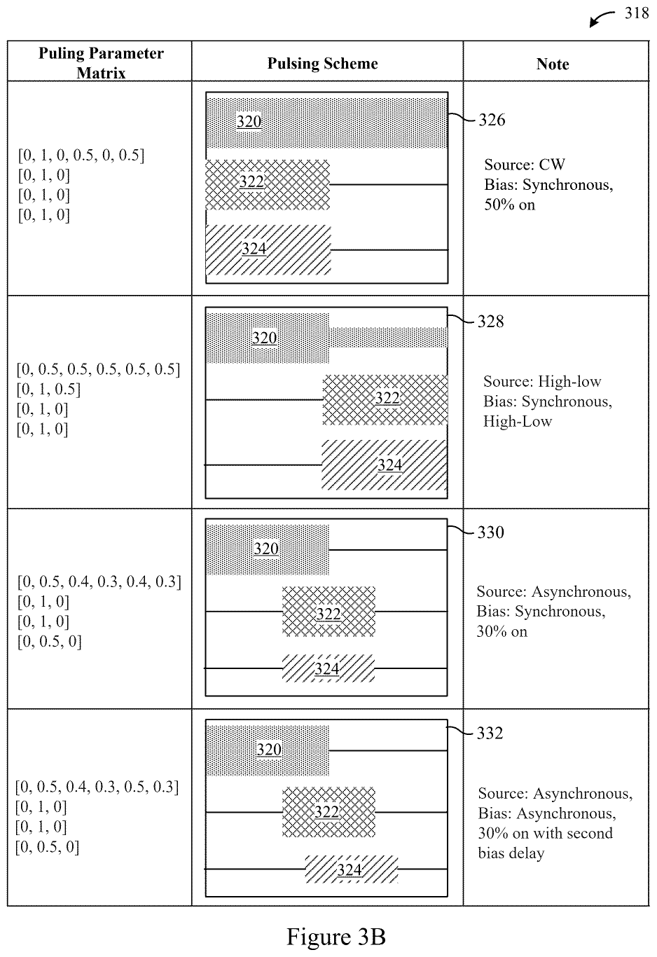

FIG. 3A illustrates a pulsing scheme template 300 and a corresponding pulsing parameter matrix 308, in accordance with various embodiments. The pulsing scheme template 300 represents an enhanced configuration that accommodates one RF source power supply and two bias power supplies, providing increased flexibility for plasma process control compared to the single bias configuration of FIG. 2A. In an embodiment, the pulsing scheme template 300 allows for independent optimization of multiple bias frequencies, such as, for example, combining radio frequency and direct current biasing, which can provide enhanced control over ion energy distributions and plasma-surface interactions.

The pulsing scheme template 300 includes timing diagrams 302, 304, and 306 that illustrate the temporal behavior of the RF source power, the first bias power, and the second bias power, respectively, during a pulsing period τ₀. The timing diagram 302 shows the RF source power modulation with the RF source power levels a₁, a₂, and a₃ corresponding to time segments t₁, t₂, and (τ₀-t₁-t₂) that collectively span the pulsing period τ₀. In various embodiments, the time segments t₁ and t₂ are normalized values between 0 and 1, and the RF source power levels a₁, a₂, and a₃ are normalized values between 0 and 1, where 0 represents no power output and 1 represents full power output.

The timing diagram 304 shows the first bias power modulation with the first bias power levels b₁, b₂, and b₃ corresponding to the time segments t₃, t₄, and (τ₀-t₃-t₄) that collectively span the pulsing period τ₀. In various embodiments, the time segments t₃ and t₄ are normalized values between 0 and 1, and the first bias power levels b₁, b₂, and b₃ are normalized values between 0 and 1, where 0 represents no power output and 1 represents full power output.

The timing diagram 306 shows the second bias power modulation with the second bias power levels c₁, c₂, and c₃ corresponding to the time segments t₅, t₆, and (τ₀-t₅-t₆) that collectively span the pulsing period τ₀. In various embodiments, the time segments t₅ and t₆ are normalized values between 0 and 1, and the second bias power levels c₁, c₂, and c₃ are normalized values between 0 and 1, where 0 represents no power output and 1 represents full power output.

The pulsing parameter matrix 308 comprises arrays 310, 312, 314, and 316 that define the pulsing scheme through timing and power level parameters of the three power supplies. The array 310 comprises the timing parameters [t1, t2, t3, t4, t5, t6] that specify the duration of each time segment within the pulsing period τ₀. In an embodiment, time segments t₁, t₂, and (τ₀-t₁-t₂) define the RF source timing, while time segments t₃, t₄, and (τ₀-t₃-t₄) define the first bias timing, and time segments t₅, t₆, and (τ₀-t₅-t₆) define the second bias timing. The array 312 comprises the RF source power level parameters [a₁, a₂, a₃], the array 314 comprises the first bias power level parameters [b₁, b₂, b₃], and the array 316 comprises the second bias power level parameters [c₁, c₂, c₃]. In various embodiments, the independent control of three separate power level arrays enables complex multi-frequency biasing schemes where different bias frequencies can operate with different timing relationships and power levels.

The pulsing scheme template 300 configuration enables generation of pulsing schemes including continuous wave RF source operation with pulsed biasing, high-low RF source power operation with synchronized or asynchronous bias pulsing, and complex multi-phase sequences involving all three power supplies. In an embodiment, the dual bias capability allows for implementation of schemes where a low frequency or direct current bias provides ion energy control while a high frequency bias influences sheath dynamics and plasma uniformity.

FIG. 3B illustrates a table 318 showing pulsing parameter matrix values for the pulsing scheme template 300 of FIG. 3A and corresponding pulsing schemes, in accordance with various embodiments. Table 318 demonstrates the practical application of the dual bias pulsing parameter matrix 308 (see FIG. 3A) by providing specific numerical values that generate distinct pulsing behaviors involving one RF source and two bias power supplies.

The first row of the table 318 demonstrates a continuous wave RF source with synchronous bias operation using the pulsing parameter matrix comprising the array [0, 1, 0, 0.5, 0, 0.5] for timing, the array [0, 1, 0] for the RF source power, the array [0, 1, 0] for the first bias power, and the array [0, 1, 0] for the second bias power. In this configuration, the RF source power operates continuously at full power while both bias power supplies operate synchronously with 50% duty cycle. A pulsing scheme 326 shows waveforms 320, 322, and 324 illustrating the temporal behavior, where the waveform 320 represents the continuous RF source power, the waveforms 322 represents the first bias powers switching between on and off states, and the waveforms 324 represents the second bias powers switching between on and off states.

The second row of the table 318 illustrates a high-low RF source power scheme with synchronous dual bias operation using the pulsing parameter matrix comprising the array [0, 0.5, 0.5, 0.5, 0.5, 0.5] for timing, the array [0, 1, 0.5] for the RF source power, the array [0, 1, 0] for the first bias power, and the array [0, 1, 0] for the second bias power. In various embodiments, this configuration produces the RF source power modulation between full power and 50% power, while both bias power supplies operate synchronously with 50% duty cycle. A pulsing scheme 328 shows waveforms 320, 322, and 324 illustrating the temporal behavior, where the waveform 320 represents the RF source power switching between high and low power states, the waveforms 322 represents the first bias powers switching between on and off states, and the waveforms 324 represents the second bias powers switching between on and off states. In some embodiments, the high-low RF source operation enables different plasma densities during different phases of the pulsing cycle while maintaining coordinated bias control for consistent ion energy characteristics.

The third row of the table 318 demonstrates asynchronous source RF operation with synchronous bias control using the pulsing parameter matrix comprising the array [0, 0.5, 0.4, 0.3, 0.4, 0.3] for timing, the array [0, 1, 0] for the RF source power, the array [0, 1, 0] for the first bias power, and the array [0, 0.5, 0] for the second bias power. In this configuration, the RF source operates asynchronously with respect to the first and second biases, which operate synchronously at 30% duty cycle. Furthermore, the RF source power is set to the full power, the first bias power is set to the full power, and the second bias power is set to 50% power level. A pulsing scheme 330 shows waveforms 320, 322, and 324 illustrating the temporal behavior, where the waveform 320 represents the RF source power switching between on and off states, the waveforms 322 represents the first bias powers switching between on and off states, and the waveforms 324 represents the second bias powers switching between low power and off states.

The fourth row of the table 318 demonstrates an asynchronous scheme involving all three power supplies using the pulsing parameter matrix comprising the array [0, 0.5, 0.4, 0.3, 0.5, 0.3] for timing, the array [0, 1, 0] for the RF source power, the array [0, 1, 0] for the first bias power, and the array [0, 0.5, 0] for the second bias power. In this configuration, the RF source, the first bias, and the second bias operated asynchronously, with the first and second biases operating at 30% duty cycle. Furthermore, the RF source power is set to the full power, the first bias power is set to the full power, and the second bias power is set to 50% power level. A pulsing scheme 332 shows waveforms 320, 322, and 324 illustrating the temporal behavior, where the waveform 320 represents the RF source power switching between on and off states, the waveforms 322 represents the first bias powers switching between on and off states, and the waveforms 324 represents the second bias powers switching between low power and off states. In an embodiment, the asynchronous operation between the two bias power supplies enables independent optimization of different aspects of ion energy control, such as using the first bias for primary ion acceleration and the second bias for fine-tuning ion energy distribution characteristics. Furthermore, the asynchronous operation allows for decoupled optimization of plasma density and ion energy control.

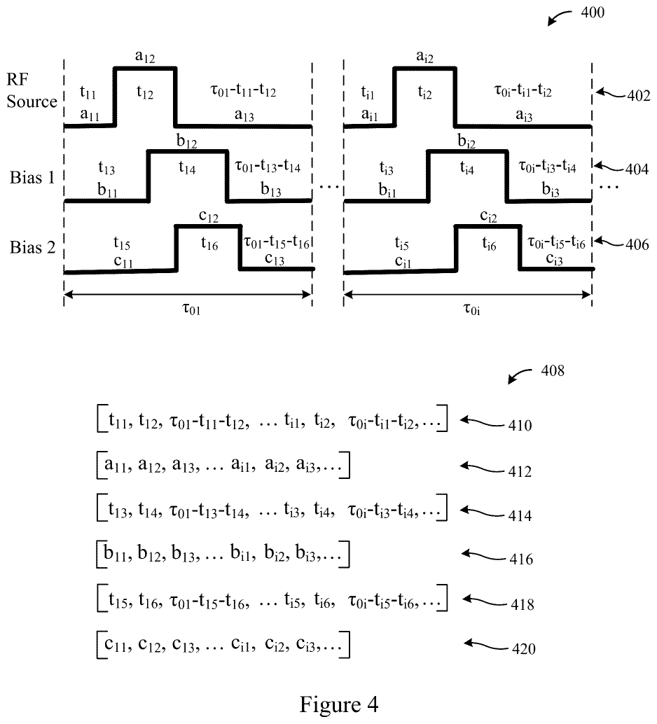

FIG. 4 illustrates a pulsing scheme template 400 and a corresponding pulsing parameter matrix 408, in accordance with various embodiments. The pulsing scheme template 400 represents a generalized configuration that accommodates multiple pulsing periods, providing enhanced flexibility for complex plasma processing applications requiring extended pulsing sequences.

The pulsing scheme template 400 includes timing diagrams 402, 404, and 406 that illustrate the temporal behavior of the RF source power, the first bias power, and the second bias power, respectively, across multiple pulsing periods τ₀ᵢ. Timing diagram 402 shows the RF source power modulation with the RF source power levels a₁₁, a₁₂, and a₁₃ corresponding to time segments t₁₁, t₁₂, and (τ₀₁-t₁₁-t₁₂) that collectively span the pulsing period τ₀₁, followed by the RF source power levels aᵢ₁, aᵢ₂, and aᵢ₃ corresponding to time segments tᵢ₁, tᵢ₂, and (τ₀ᵢ-tᵢ₁-tᵢ₂) that collectively span the pulsing period τ₀ᵢ. In various embodiments, the time segments t₁₁, t₁₂, tᵢ₁, and tᵢ₂ are normalized values between 0 and 1, and the RF source power levels a₁₁, a₁₂, a₁₃, aᵢ₁, aᵢ₂, and aᵢ₃ are normalized values between 0 and 1, where 0 represents no power output and 1 represents full power output.

Timing diagram 404 shows the first bias power modulation with the first bias power levels b₁₁, b₁₂, and b₁₃ corresponding to time segments t₁₃, t₁₄, and (τ₀₁-t₁₃-t₁₄) that collectively span the pulsing period τ₀₁, followed by the first bias levels bᵢ₁, bᵢ₂, and bᵢ₃ corresponding to time segments tᵢ₃, tᵢ₄, and (τ₀ᵢ-tᵢ₃-tᵢ₄) that collectively span the pulsing period τ₀ᵢ. In various embodiments, the time segments t₁₃, t₁₄, tᵢ₃, and tᵢ₄ are normalized values between 0 and 1, and the first bias power levels b₁₁, b₁₂, b₁₃, bᵢ₁, bᵢ₂, and bᵢ₃ are normalized values between 0 and 1, where 0 represents no power output and 1 represents full power output.

Timing diagram 406 shows the second bias power modulation with the second bias power levels c₁₁, c₁₂, and c₁₃ corresponding to time segments t₁₅, t₁₆, and (τ₀₁-t₁₅-t₁₆) that collectively span the pulsing period τ₀₁, followed by the second bias levels cᵢ₁, cᵢ₂, and cᵢ₃ corresponding to time segments tᵢ₅, tᵢ₆, and (τ₀ᵢ-tᵢ₅-tᵢ₆) that collectively span the pulsing period τ₀ᵢ. In various embodiments, the time segments t₁₅, t₁₆, tᵢ₅, and tᵢ₆ are normalized values between 0 and 1, and the second bias power levels c₁₁, c₁₂, c₁₃, cᵢ₁, cᵢ₂, and cᵢ₃ are normalized values between 0 and 1, where 0 represents no power output and 1 represents full power output.

The pulsing parameter matrix 408 comprises arrays 410, 412, 414, 416, 418, and 420 that define the multi-period pulsing scheme through timing and power level parameters. The array 410 comprises RF source timing parameters [t₁₁, t₁₂, τ₀₁-t₁₁-t₁₂,. . . , tᵢ₁, tᵢ₂, τ₀ᵢ-tiᵢ₁-tiᵢ₂, . . .], while the array 412 comprises corresponding RF source power level parameters [a₁₁, a₁₂, a₁₃, . . . , aᵢ₁, aᵢ₂, aᵢ₃, . . .]. The array 414 comprises first bias timing parameters [t₁₃, t₁₄, τ₀₁-t₁₃-t₁₄, . . . , tᵢ₃, tᵢ₄, τ₀ᵢ-tᵢ₃-tᵢ₄, . . .] for the first bias power supply, while the array 416 comprises corresponding first bias power level parameters [b₁₁, b₁₂, b₁₃, . . . , bᵢ₁, bᵢ₂, bᵢ₃, . . .]. The array 418 comprises second bias timing parameters [t₁₅, t₁₆, τ₀₁-t₁₅-t₁₆, . . . , tᵢ₅, tᵢ₆, τ₀ᵢ-tᵢ₅-tᵢ₆, . . .] for the second bias power supply, while the array 420 comprises corresponding second bias power level parameters [c₁₁, c₁₂, c₁₃, . . . , cᵢ₁, cᵢ₂, cᵢ₃, . . .].

In various embodiments, the pulsing scheme template 400 enables generation of multi-period pulsing schemes where each period can have distinct characteristics optimized for specific process phases. In an embodiment, early periods might use high power and aggressive pulsing for rapid material removal, while later periods might use gentler conditions for precise endpoint control or surface finishing. The multi-period capability allows for implementation of pulsing schemes where plasma conditions evolve systematically throughout processing, such as gradually reducing power levels, changing duty cycles, or modifying phase relationships between power supplies as the process progresses.

The generalized pulsing scheme template 400 provides flexibility for complex plasma processing applications, while maintaining a structured approach to parameter optimization. In various embodiments, the number of pulsing periods can be selected based on process requirements. In some embodiments, two are three pulsing periods may be used to balance process control capabilities with computational efficiency.

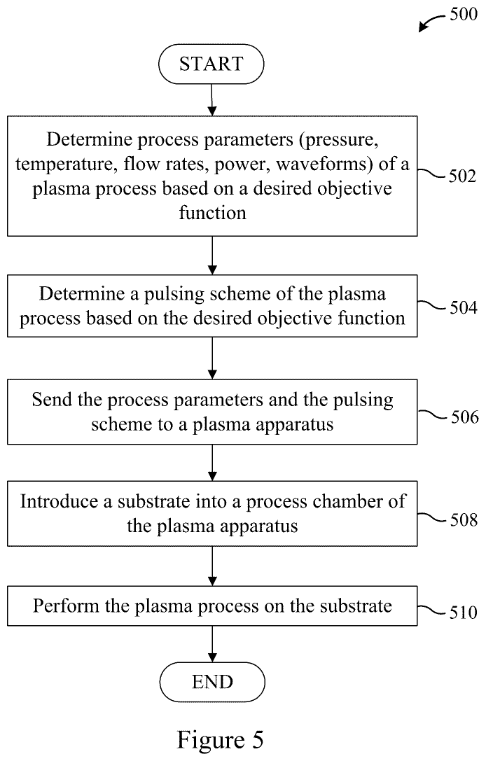

FIG. 5 illustrates a flow diagram of a substrate processing method 500, in accordance with various embodiments. Although shown in a particular sequence, it should be appreciated that the steps of the method 500 may be performed in any suitable sequence. Furthermore, one or more steps of the method 500 may be omitted.

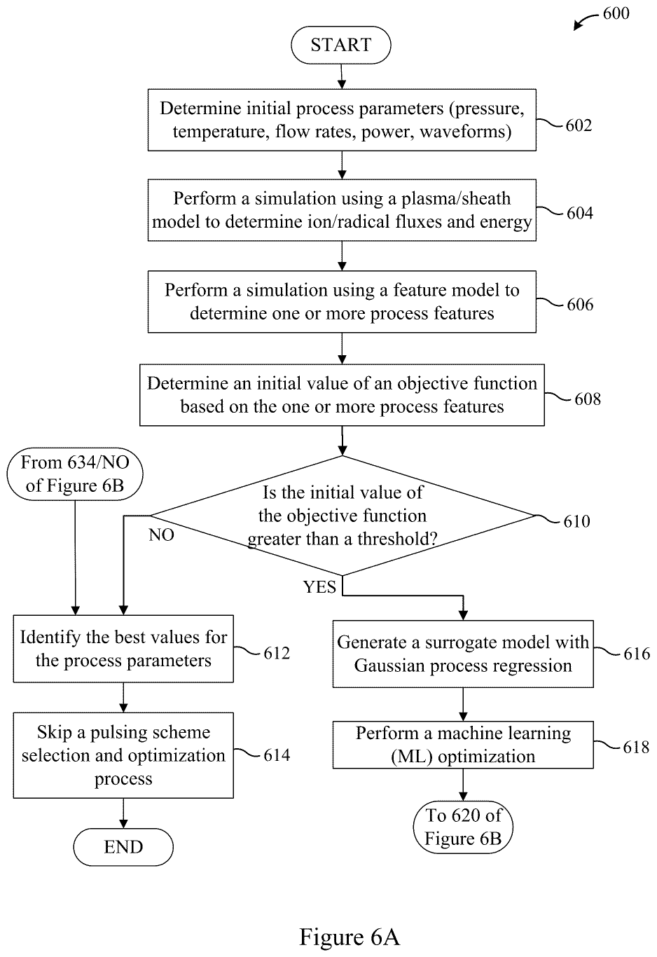

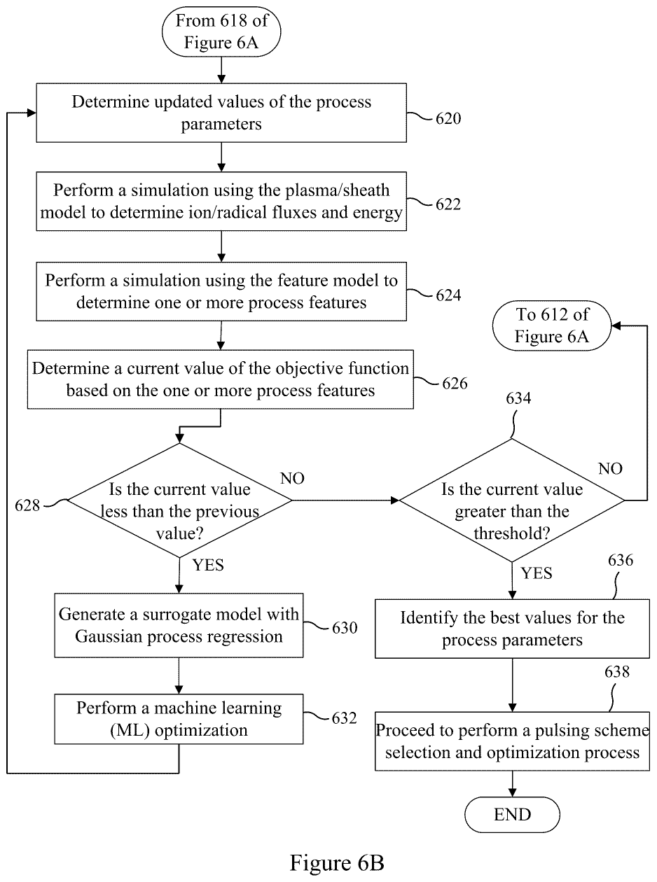

The method starts with step 502, where process parameters of a plasma process are determined based on a desired objective function. The process parameters may include pressure, temperature, flow rates, power levels, and waveforms that define the operating conditions for a plasma processing apparatus (e.g., plasma apparatus 100 of FIG. 1). In various embodiments, the determination of the process parameters involves iterative optimization using simulation models and optimization algorithms such as ML and Bayesian optimizations. The desired objective function may represent process goals such as etch rate uniformity, selectivity, critical dimension control, aspect ratio dependent etching bias minimization, or the like. In an embodiment, the optimization process uses plasma/sheath models to calculate ion and radical fluxes and energy distributions, followed by feature models (e.g., surface/profile model) to determine process outcomes and evaluate the single objective function. In some embodiments, step 502 may be performed according to a method 600 described below with reference to FIGS. 6A and 6B.

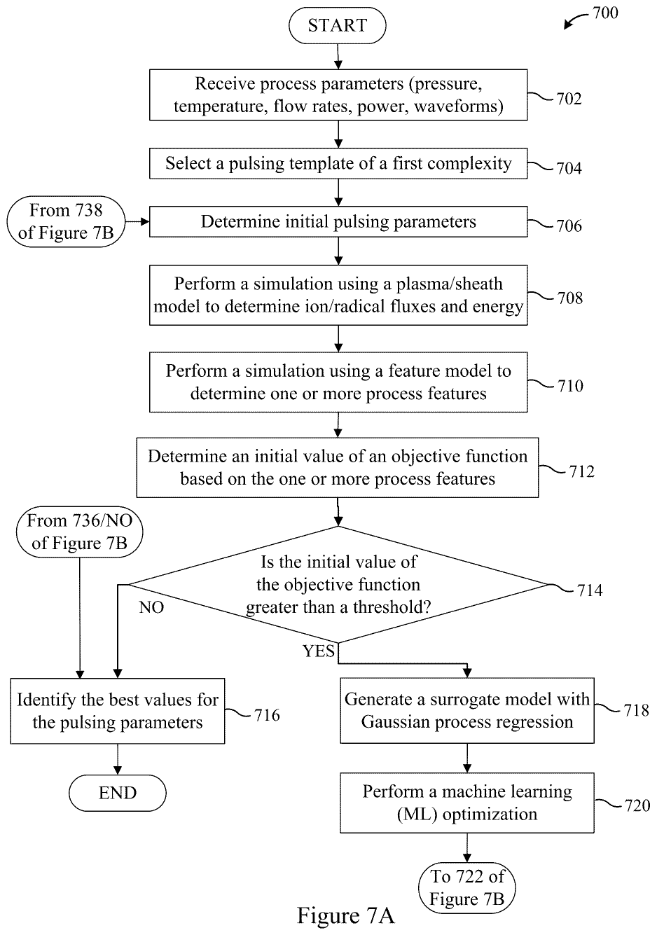

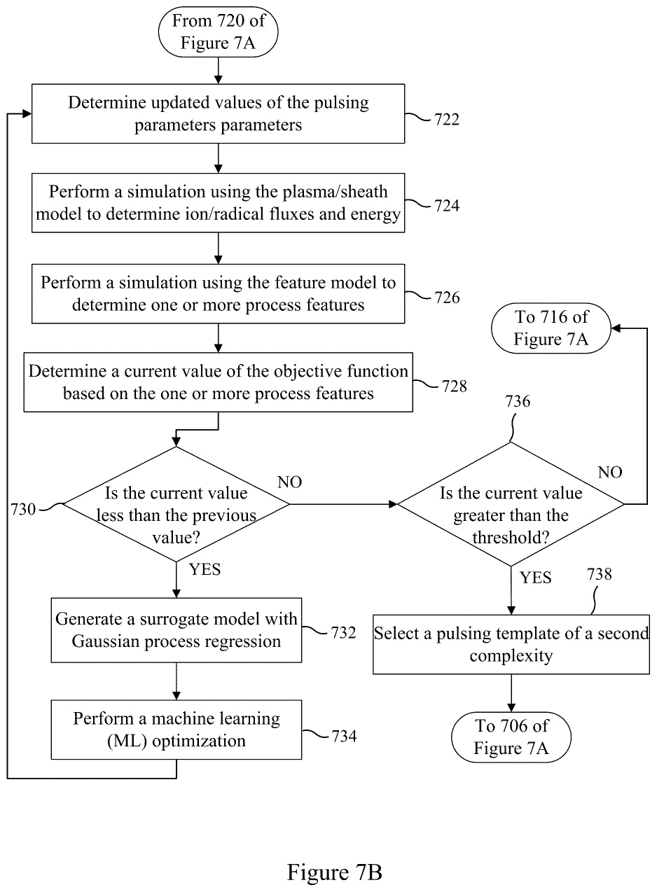

In step 504, a pulsing scheme of the plasma process is determined based on the desired objective functions. In some embodiments, the pulsing scheme determination utilizes the pulsing scheme templates 200, 300, and 400 described in FIGS. 2A, 3A, and 4, respectively, to systematically explore pulsing parameter space. The determination process may begin with selecting a simpler pulsing scheme template (e.g., pulsing scheme template 200 of FIG. 2A) and progress to more complex pulsing scheme templates (e.g., pulsing scheme template 300 of FIG. 3A or pulsing scheme template 400 of FIG. 4) if the objective function requirements are not satisfied. In an embodiment, the pulsing scheme optimization employs ML techniques in conjunction Bayesian optimization to efficiently identify optimal parameter combinations. In some embodiments, step 504 may be performed according to a method 700 described below with reference to FIGS. 7A and 7B.

In step 506, the process parameters and the pulsing scheme are sent to the plasma apparatus. The transmission of parameters may occur through digital communication interfaces that couple a controller (e.g., controller 124 of FIG. 1) to the plasma processing apparatus. In various embodiments, the process parameters are converted into appropriate control signals (e.g., control signals 126 of FIG. 1) for gas flow controllers, pressure regulators, temperature controllers, and other process control systems. The pulsing scheme parameters are transmitted to power supply control systems (e.g., RF source power supply 116A and/or 116B, and/or bias power supply 122A and/or 122B) that implement the specified timing sequences and power levels.

In step 508, a substrate (e.g., substrate 106 of FIG. 1) is introduced into a process chamber (e.g., process chamber 102 of FIG. 1) of the plasma apparatus. The substrate introduction may be performed using automated substrate handling systems including load locks, transfer arms, and positioning mechanisms. In various embodiments, the substrate 106 is positioned on a chuck or substrate support (e.g., chuck 104 of FIG. 1) within the process chamber and secured using electrostatic or mechanical clamping mechanisms. The substrate introduction step may also include chamber conditioning procedures, such as pressure stabilization, temperature equilibration, and/or gas purging to establish proper processing conditions.

In step 510, the plasma process is performed on the substrate using the process parameters and the pulsing scheme. In some embodiments, the plasma process may include generating plasma (e.g., plasma 118 of FIG. 1) within the process chamber using the optimized RF source power parameters and applying the optimized bias power parameters to control ion energy and directionality. In various embodiments, the pulsing scheme is executed according to the timing and power level specifications determined in step 504. The plasma process may include etching, deposition, surface modification, or other plasma-assisted operations depending on the specific application requirements. In an embodiment, the process execution includes real-time monitoring and control to maintain the specified processing conditions throughout the operation, ensuring that the benefits of the optimization are realized in the actual processing results.

FIGS. 6A and 6B illustrate a flow diagram of a method 600 for plasma process parameter optimization, in accordance with various embodiments. Although shown in a particular sequence, it should be appreciated that the steps of the method 600 may be performed in any suitable sequence. Furthermore, one or more steps of the method 600 may be omitted. In some embodiments, the method 600 may be used to implement step 502 of the method 500 (shown in FIG. 5). In an embodiment, the method 600 represents the first stage of a two-stage optimization process that establishes optimal baseline conditions under continuous wave operation before advancing to more complex pulsing scheme optimization when needed.

The method 600 starts with step 602, where initial process parameters including pressure, temperature, flow rates, power levels, and/or waveforms are determined. The initial process parameters may be based on previous experience, process recipes, or engineering estimates for the specific plasma processing application. In various embodiments, the initial parameters provide a starting point for the optimization process. In an embodiment, the initial parameter selection may consider process outcomes and material properties to establish reasonable starting conditions for the optimization algorithm.

In step 604, a simulation is performed using a plasma/sheath model to determine ion and radical fluxes and energy distributions. The plasma/sheath model calculates the plasma properties and species distributions based on the process parameters from step 602. In various embodiments, the simulation determines ion densities, radical concentrations, electron temperatures, and/or energy distributions of species impacting the substrate surface.

In step 606, a simulation is performed using a feature model to determine one or more process features. The feature model utilizes the ion and radical fluxes and energy distributions from step 604 to calculate process outcomes such as etch rates, deposition rates, profile evolution, surface chemistry effects, or the like. The process features may include critical dimensions, etch depths, sidewall angles, surface roughness, or other metrics relevant to the specific processing application. In an embodiment, the feature model comprises a surface/profile model.

In step 608, an initial value of an objective function is determined based on the one or more process features from step 606. The objective function represents the process goals and may include single or multiple performance metrics. In various embodiments, the objective function may minimize etch depth differences between features of different aspect ratios, maximize etch rate uniformity, optimize selectivity between different materials, achieve target critical dimensions, or the like. In an embodiment, multiple process features may be combined into a single objective function using weighted combinations that reflect the relative importance of different process requirements.

In step 610, the method 600 determines whether the initial value of the objective function is greater than a threshold. The threshold represents the acceptable level of process performance and serves as a decision point for determining whether additional optimization is needed. In response to determining at step 610 that the initial value of the objective function is less than or equal to the threshold, indicating acceptable performance, the method 600 proceeds to step 612.

In step 612, the best values for the process parameters are identified. In some embodiments, the current parameter values are identified as the best since they achieve the desired process performance. In step 614, the pulsing scheme selection and optimization process is skipped since the continuous wave operation with the optimized process parameters provides satisfactory results. After step 614, the method 600 ends.

In response to determining at step 610 that the initial value of the objective function is greater than the threshold, indicating insufficient performance, the method 600 proceeds to step 616. In step 616, a surrogate model with Gaussian process regression is generated to model the relationship between process parameters and objective function values.

In step 618, a machine learning (ML) optimization is performed. In various embodiments, the ML techniques may include neural networks, support vector machines, or other algorithms that learn from the simulation data to guide the optimization process. In an embodiment, the ML optimization comprises a Bayesian optimization that provides a systematic approach for exploring the parameter space to find improved solutions.

In step 620, updated values of the process parameters are determined based on the optimization algorithms. The updated parameters represent the next evaluation point suggested by the ML optimization. In step 622, a simulation is performed using the plasma/sheath model with the updated parameters to determine ion and radical fluxes and energy distributions. In step 624, a simulation is performed using the feature model to determine one or more process features based on the updated plasma conditions.

In step 626, a current value of the objective function is determined based on the one or more process features determined in step 624. In step 628, the method 600 determines whether the current value of the objective function is less than the previous value of the objective function. In response to determining at step 628 that the current value of the objective function is less than the previous value of the objective function, the method 600 proceeds to step 630.

In step 630, a surrogate model with Gaussian process regression is generated. In step 632, an ML optimization is performed. Step 632 is similar to step 618, and the description is not repeated herein. After step 632, the method 600 proceeds back to step 620. In some embodiments, steps 620-632 may be performed one or more times until the value of the objective function can no longer improve.

In response to determining at step 628 that the current value of the objective function is greater than or equal to the previous value of the objective function, the method 600 proceeds to step 634. In step 634, the method 600 determines whether the current value of the objective function is greater than the threshold.

In response to determining at step 634 that the current value of the objective function is less than or equal to the threshold, indicating acceptable performance, the method 600 proceeds back to step 612. In step 612, the best values for the process parameters are identified. In some embodiments, the current parameter values are identified as the best since they achieve the desired process performance. In step 614, the pulsing scheme selection and optimization process is skipped since the continuous wave operation with optimized process parameters provides satisfactory results. After step 614, the method 600 ends.

In response to determining at step 634 that the current value of the objective function is greater than the threshold, indicating insufficient performance, the method 600 proceeds to step 636. In step 636, the best values for the process parameters are identified. In some embodiments, the current parameter values are identified as the best. In step 638, the method 600 proceeds to perform pulsing scheme selection and optimization process as a second stage of the overall optimization process. In some embodiments, step 638 comprises proceeding to perform a method 700 of FIGS. 7A and 7B. After performing step 638, the method 600 ends.

FIGS. 7A and 7B illustrate a flow diagram of a method 700 for pulsing scheme selection and optimization, in accordance with various embodiments. Although shown in a particular sequence, it should be appreciated that the steps of the method 700 may be performed in any suitable sequence. Furthermore, one or more steps of the method 700 may be omitted. In some embodiments, the method 700 may be used to implement step 504 of the method 500 (shown in FIG. 5). In an embodiment, the method 700 represents the second stage of the optimization process that is initiated when continuous wave parameter optimization fails to achieve desired process performance, needing more sophisticated pulsing control to meet process objectives.

The method 700 starts with step 702, where process parameters including pressure, temperature, flow rates, power levels, and/or waveforms are received. In some embodiments, the process parameters may be the output from the method 600 described above with reference to FIGS. 6A and 6B, providing baseline conditions for the pulsing scheme optimization.

In step 704, a first pulsing template of a first complexity is selected. In an embodiment, the first pulsing template may correspond to the pulsing scheme template 200 shown in FIG. 2A, which provides pulsing capability with one RF source power supply and one bias power supply. The first pulsing template selection establishes the parameter structure and degrees of freedom available for the optimization process.

In step 706, the method 700 determines initial pulsing parameters corresponding to the selected pulsing template. The initial pulsing parameters include timing values and power level values for the RF source and bias power supplies as defined by the pulsing template structure. In various embodiments, the initial parameters may be based on engineering estimates, previous experience, or random initialization within acceptable ranges. The initial parameters provide a starting point for the iterative optimization process.

In step 708, a simulation is performed using a plasma/sheath model to determine ion and radical fluxes and energy distributions based on the initial pulsing parameters. The plasma/sheath model accounts for the temporal variations in power levels specified by the pulsing template. In step 710, a simulation is performed using a feature model to determine one or more process features based on the plasma conditions from step 708. Step 710 is similar to step 606 (shown in FIG. 6A), and the description is not repeated herein.

In step 712, an initial value of an objective function is determined based on the one or more process features from step 710. In some embodiments, the objective function represents the same process goals used in the continuous wave optimization described in FIGS. 6A and 6B but now evaluated under pulsed operating conditions. In step 714, the method 700 determines whether the initial value of the objective function is greater than a threshold.

In response to determining at step 714 that the initial value of the objective function is less than or equal to the threshold, indicating acceptable performance, the method 700 proceeds to step 716. In step 716, the best values for the pulsing parameters are identified. In some embodiments, the current parameter values of the pulsing parameters are identified as the best since they achieve the desired process performance. After step 716, the method 700 ends.

In response to determining at step 714 that the initial value of the objective function is greater than the threshold, indicating insufficient performance, the method 700 proceeds to step 718. In step 718, a surrogate model with Gaussian process regression is generated to model the relationship between pulsing parameters and objective function values.

In step 702, a machine learning (ML) optimization is performed. In various embodiments, the ML techniques may include neural networks, support vector machines, or other algorithms that learn from the simulation data to guide the optimization process. In an embodiment, the ML optimization comprises a Bayesian optimization that provides a systematic approach for exploring the parameter space to find improved solutions.

In step 722, updated values of the pulsing parameters are determined based on the ML optimization. The updated pulsing parameters represent the next evaluation point suggested by the ML optimization processes performed in step 720. In step 724, a simulation is performed using the plasma/sheath model with the updated pulsing parameters to determine ion and radical fluxes and energy distributions. In step 726, a simulation is performed using the feature model to determine one or more process features based on the updated plasma conditions. In an embodiment, the feature model comprises a surface/profile model.

In step 728, a current value of the objective function is determined based on the one or process features from step 726. In step 730, the method 700 determines whether the current value of the objective function is less than the previous value of the objective function. In response to determining at step 730 that the current value of the objective function is less than the previous value of the objective function, the method 700 proceeds to step 732.

In step 732, a surrogate model with Gaussian process regression is generated. In step 734, an ML optimization is performed. Step 734 is similar to step 720, and the description is not repeated herein. After step 734, the methods 700 proceeds back to step 722. In some embodiments, steps 722-734 may be performed one or more times until the value of the objective function can no longer improve.

In response to determining at step 730 that the current value of the objective function is greater than or equal to the previous value of the objective function, the method 700 proceeds to step 736. In step 736, the method 700 determines whether the current value of the objective function is greater than the threshold.

In response to determining at step 736 that the current value of the objective function is less than or equal to the threshold, indicating acceptable performance, the method 700 proceeds back to step 716. In step 716, the best values for the pulsing parameters are identified. In some embodiments, the current values of the pulsing parameters are identified as the best. After step 716, the method 700 ends.

In response to determining at step 736 that the current value of the objective function is greater than the threshold, indicating insufficient performance, the method 700 proceeds to step 738. In step 738, a second pulsing scheme template of increased complexity is selected. In an embodiment, the second pulsing scheme template may correspond to the pulsing scheme template 300 shown in FIG. 3A, which provides pulsing capability with one RF source power supply and two bias power supplies with a single puling period. In another embodiment, the second pulsing scheme template may correspond to the pulsing scheme template 400 shown in FIG. 4, which provides pulsing capability with one RF source power supply and two bias power supplies with multiple pulsing periods.

After performing step 738, the method returns to step 706 to perform the pulsing parameter optimization for the second pulsing scheme template. In an embodiment, by progressively increasing complexity of selected pulsing scheme templates, the method 700 allows for efficient optimization by starting with simpler pulsing scheme templates and increasing complexity when needed to achieve process objectives.

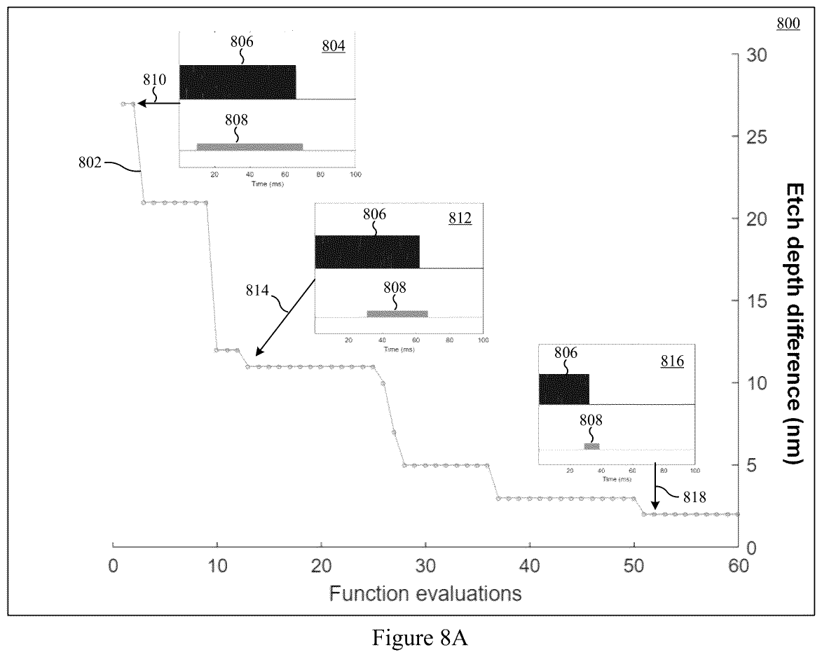

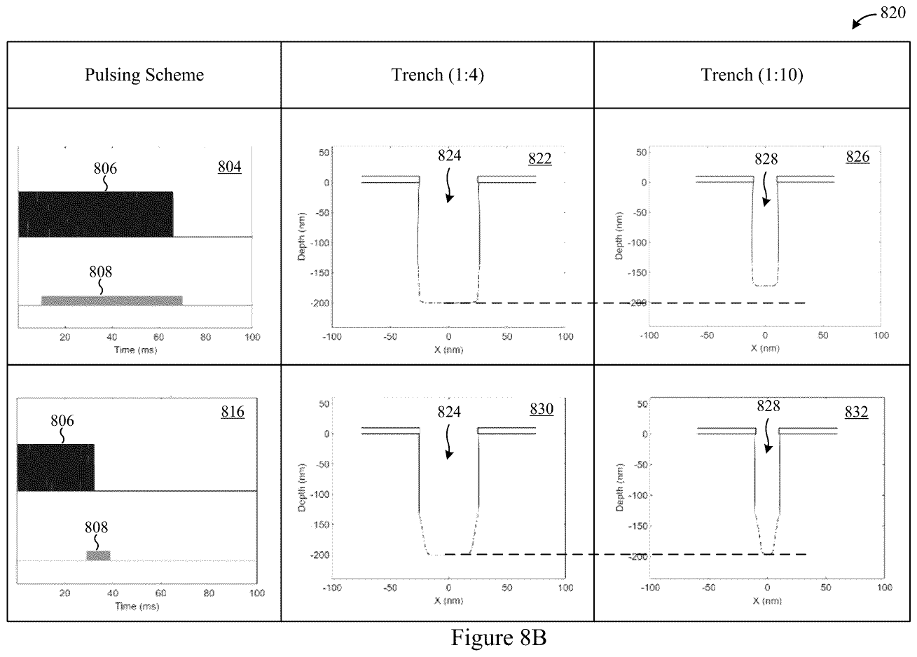

FIG. 8A illustrates a graph 800 showing a dependence of an objective function on iterations and corresponding pulsing schemes, in accordance with various embodiments. In particular, the graph 800 demonstrates the convergence behavior of the optimization process performed according to the method 700 of FIGS. 7A and 7B for a pulsing scheme template that includes one RF source power supply and one bias power supply. In an embodiment, the graph 800 shows the optimization of pulsing scheme for minimizing aspect ratio dependent etching in argon/chlorine etching of silicon.

A curve 802 represents a dependence of the objective function on the number of function evaluations. In the illustrated embodiment, the objective function represents the difference in etch depths between trenches of different aspect ratios, where minimizing the depth difference indicates improved loading uniformity and reduced aspect ratio dependent etching effects.

A pulsing scheme 804 illustrates waveforms 806 and 808 that correspond to a first value of the curve 802 indicated by an arrow 810. A pulsing scheme 812 illustrates waveforms 806 and 808 that correspond to a second value (less than the first value) of the curve 802 indicated by an arrow 814. A pulsing scheme 816 illustrates waveforms 806 and 808 that correspond to a third value (less than the second value) of the curve 802 indicated by an arrow 818. The waveforms 806 show the RF source power modulation, while the waveforms 808 show the bias power modulation. In the illustrated embodiment, the pulsing scheme 816 is identified as the best pulsing scheme.

FIG. 8B illustrates a table 820 showing pulsing schemes and corresponding features formed by a plasma process using the pulsing schemes, in accordance with various embodiments. The table 820 includes multiple rows showing different pulsing schemes 804 and 816, and associated trench profiles. The waveforms 806 and 808 represent the temporal behavior of the RF source power and the bias power, respectively, for each of the pulsing schemes 804 and 816. In various embodiments, the pulsing schemes 804 and 816 demonstrate different duty cycles, timing relationships, and power levels that result from the optimization process described in FIG. 8A.

Graphs 822 and 826 show trench profiles that correspond to the pulsing scheme 804. Graphs 830 and 832 show trench profiles that correspond to the pulsing scheme 816. In particular, graphs 822 and 830 show profiles of a trench 824 with a 1:4 aspect ratio, while graphs 826 and 832 shows profiles of a trench 828 with a 1:10 aspect ratio. Graphs 822, 826, 830, and 832 show that the etch depth difference between the trenches 824 and 828 is improved as a pulsing scheme changes from the pulsing scheme 804 to the pulsing scheme 816.

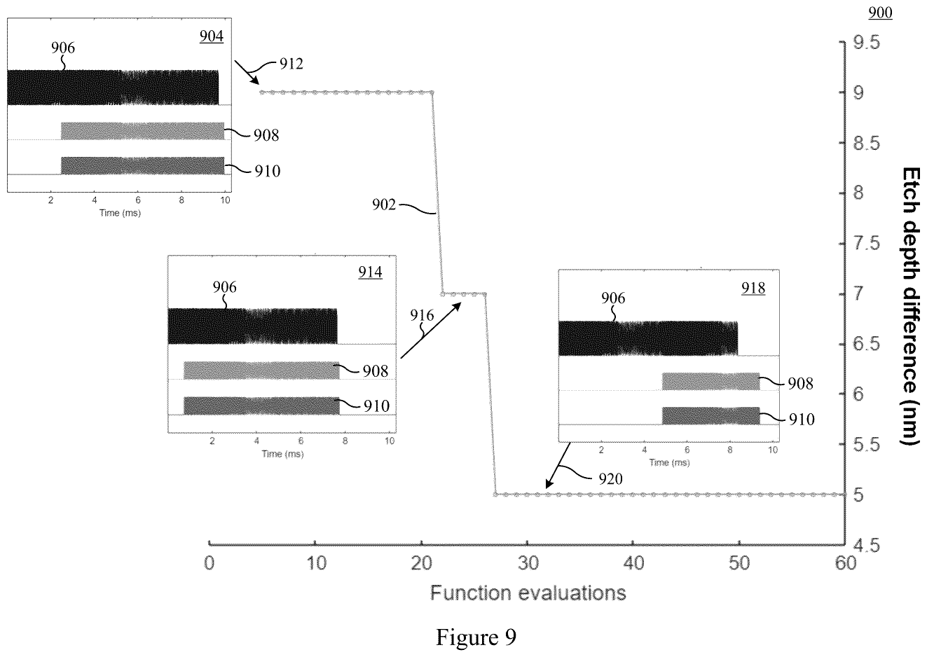

FIG. 9 illustrates a graph 900 showing a dependence of an objective function on iterations and corresponding pulsing schemes, in accordance with various embodiments. In particular, the graph 900 demonstrates the convergence behavior of the optimization process performed according to the method 700 of FIGS. 7A and 7B for a pulsing scheme template that includes one RF source power supply and two bias power supplies. In an embodiment, the graph 900 shows the optimization of pulsing scheme for minimizing aspect ratio dependent etching in argon/chlorine etching of silicon.

A curve 902 represents a dependence of the objective function on the number of function evaluations. In the illustrated embodiment, the objective function represents the difference in etch depths between trenches of different aspect ratios, where minimizing the depth difference indicates improved loading uniformity and reduced aspect ratio dependent etching effects.

A pulsing scheme 904 illustrates waveforms 906, 908 and 910 that correspond to a first value of the curve 902 indicated by an arrow 912. A pulsing scheme 914 illustrates waveforms 906, 908 and 910 that correspond to a second value (less than the first value) of the curve 902 indicated by an arrow 916. A pulsing scheme 918 illustrates waveforms 906, 908 and 910 that correspond to a third value (less than the second value) of the curve 902 indicated by an arrow 920. The waveforms 906 show the RF source power modulation, the waveforms 908 show the first bias power modulation, and the waveforms 910 show the second bias power modulation. In the illustrated embodiment, the pulsing scheme 918 is identified as the best pulsing scheme.

FIG. 10 is a block diagram of a computing system 1000, in accordance with various embodiments. The computing system 1000 may be used for implementing the devices and methods disclosed herein. In some embodiments, the computing system 1000 may be used for implementing the controller 124 of FIG. 1. In other embodiments, the computing system 1000 may be used for implementing the method 500 of FIG. 5, the method 600 of FIGS. 6A and 6B, and the method 700 of FIGS. 7A and 7B.

The computing system 1000 includes a processing unit 1002. The processing unit includes one or more central processing units (CPUs) 1014, memory 1008, and may further include a mass storage device 1004, a video adapter 1010, and an I/O interface 1012 connected to a bus 1020.

The bus 1020 may be one or more of any type of several bus architectures including a memory bus or memory controller, a peripheral bus, or a video bus. Each of the one or more CPUs 1014 may comprise any type of electronic data processor. The memory 1008 may comprise any type of non-transitory system memory such as static random access memory (SRAM), dynamic random access memory (DRAM), synchronous DRAM (SDRAM), read-only memory (ROM), or a combination thereof. In an embodiment, the memory 1008 may include ROM for use at boot-up, and DRAM for program and data storage for use while executing programs.

The mass storage device 1004 may comprise any type of non-transitory computer-readable storage device (or medium) configured to store instructions, data, programs, and other information and to make the instructions, data, programs, and other information accessible via the bus 1020. The mass storage device 1004 may comprise, for example, one or more of a solid state drive, hard disk drive, a magnetic disk drive, or an optical disk drive. In some embodiments, the one or more CPUs 1014, when executing instructions stored in the mass storage device 1004, perform one or more steps of the method 500 of FIG. 5, one or more steps of the method 600 of FIGS. 6A and 6B, and/or one or more steps of the method 700 of FIGS. 7A and 7B.

The video adapter 1010 and the I/O interface 1012 provide interfaces to couple external input and output devices to the processing unit 1002. As illustrated, examples of input and output devices include a display 1018 coupled to the video adapter 1010 and a mouse, keyboard, or printer 1016 coupled to the I/O interface 1012. Other devices may be coupled to the processing unit 1002, and additional or fewer interface cards may be utilized. For example, a serial interface such as Universal Serial Bus (USB) (not shown) may be used to provide an interface for an external device.

The processing unit 1002 also includes one or more network interfaces 1006, which may comprise wired links, such as an Ethernet cable, or wireless links to access different networks. The network interfaces 1006 allow the processing unit 1002 to communicate with remote units via the networks. In an embodiment, the processing unit 1002 is coupled to a local-area network or a wide-area network for data processing and communications with remote devices, such as other processing units, the Internet, or remote storage facilities.

Example embodiments of the disclosure are described below. Other embodiments can also be understood from the entirety of the specification as well as the claims filed herein.

Example 1. A method including: determining process parameters of a plasma process based on a desired objective function; determining a pulsing scheme of the plasma process based on the desired objective function, where the pulsing scheme includes a pulsing petameter matrix including timing and power-level parameters of a radio frequency (RF) source power supply and a bias power supply; sending the process parameters and the pulsing scheme to a plasma apparatus; introducing a substrate into a process chamber of the plasma apparatus; and performing the plasma process on the substrate using the process parameters and the pulsing scheme.

Example 2. The method of example 1, where determining the process parameters includes: iteratively updating values of the process parameters until no further reduction of the desired objective function is achieved; and in response to determining that the desired objective function is greater than a threshold: identifying updated values of the process parameters as the best values of the process parameters; and proceeding with the determining the pulsing scheme.

Example 3. The method of example 2, further including: in response to determining that the desired objective function is less than or equal to the threshold: identifying the updated values of the process parameters as the best values of the process parameters; and skipping the determining the pulsing scheme.

Example 4. The method of any of examples 2 and 3, where iteratively updating the values of the process parameters includes: performing a first simulation with the values of the process parameters using a plasma/sheath model to determine plasma parameters; performing a second simulation with the plasma parameters using a feature model to determine one or more process features; determining a current value of the desired objective function based on the one or more process features; and determining whether the current value of the desired objective function is less than a previous value of the desired objective function.

Example 5. The method of example 4, further including, in response to determining that the current value of the desired objective function is less than the previous value of the desired objective function, performing a machine learning process.

Example 6. The method of example 5, where performing the machine learning process includes performing a Bayesian optimization process.

Example 7. The method of any of examples 1 to 6, where determining the pulsing scheme includes: selecting a first pulsing template of a first complexity; iteratively updating values of first pulsing parameters corresponding to the first pulsing template until no further reduction of the desired objective function is achieved; and in response to determining that the desired objective function is less than or equal to a threshold: identifying updated values of the first pulsing parameters as the best values of the first pulsing parameters.

Example 8. The method of example 7, where iteratively updating the values of the first pulsing parameters includes: performing a first simulation with the values of the first pulsing parameters using a plasma/sheath model to determine first plasma parameters; performing a second simulation with the first plasma parameters using a feature model to determine one or more first process features; determining a current first value of the desired objective function based on the one or more first process features; and determining whether the current first value of the desired objective function is less than a previous first value of the desired objective function.

Example 9. The method of example 8, further including, in response to determining that the current first value of the desired objective function is less than the previous first value of the desired objective function, performing a machine learning process.

Example 10. The method of example 9, where performing a machine learning process includes performing a Bayesian optimization process.

Example 11. The method of example 10, further including: in response to determining that the desired objective function is greater than the threshold: selecting a second pulsing template of a second complexity greater than the first complexity; iteratively updating values of second pulsing parameters corresponding to the second pulsing template until no further reduction of desired objective function is achieved; and in response to determining that the value of the desired objective function is less than or equal to the threshold: identifying updated values of the second pulsing parameters as the best values of the second pulsing parameters.

Example 12. The method of example 11, where iteratively updating the values of the second pulsing parameters includes: performing a third simulation with the values of the second pulsing parameters using the plasma/sheath model to determine second plasma parameters; performing a fourth simulation with the second plasma parameters using the feature model to determine one or more second process features; determining a current second value of the desired objective function based on the one or more second process features; and determining whether the current second value of the desired objective function is less than a previous second value of the desired objective function.

Example 13. A system including: a plasma apparatus configured to: receive a substrate in a process chamber; receive process parameters and a pulsing scheme for a plasma process from a controller; perform the plasma process on the substrate using the process parameters and the pulsing scheme; and the controller coupled to the plasma apparatus, where the controller is configured to: determine the process parameters of the plasma process based on a desired objective function; determine the pulsing scheme of the plasma process based on the desired objective function, where the pulsing scheme includes a pulsing petameter matrix including timing and power-level parameters of a radio frequency (RF) source power supply and a bias power supply; and send the process parameters and the pulsing scheme to the plasma apparatus.

Example 14. The system of example 13, where determining the process parameters includes: iteratively updating values of the process parameters until no further reduction of the desired objective function is achieved; and in response to determining that the desired objective function is greater than a threshold: identifying updated values of the process parameters as the best values of the process parameters; and proceeding with the determining the pulsing scheme.

Example 15. The system of example 14, where the controller is further configured to: in response to determining that the desired objective function is less than or equal to the threshold: identify the updated values of the process parameters as the best values of the process parameters; and skip the determining the pulsing scheme.

Example 16. The system of any of examples 14 and 15, where iteratively updating the values of the process parameters includes: performing a first simulation with the values of the process parameters using a plasma/sheath model to determine plasma parameters; performing a second simulation with the plasma parameters using a feature model to determine one or more process features; determining a current value of the desired objective function based on the one or more process features; and determining whether the current value of the desired objective function is less than a previous value of the desired objective function.

Example 17. The system of example 16, further including, in response to determining that the current value of the desired objective function is less than the previous value of the desired objective function, performing a machine learning process.

Example 18. The system of example 17, where performing the machine learning process includes performing a Bayesian optimization process.

Example 19. The system of any of examples 13 to 18, where determining the pulsing scheme includes: selecting a first pulsing template of a first complexity; iteratively updating values of first pulsing parameters corresponding to the first pulsing template until no further reduction of the desired objective function is achieved; and in response to determining that the desired objective function is less than or equal to a threshold: identifying updated values of the first pulsing parameters as the best values of the first pulsing parameters.

Example 20. The system of example 19, where iteratively updating the values of the first pulsing parameters includes: performing a first simulation with the values of the first pulsing parameters using a plasma/sheath model to determine first plasma parameters; performing a second simulation with the first plasma parameters using a feature model to determine one or more first process features; determining a current first value of the desired objective function based on the one or more first process features; and determining whether the current first value of the desired objective function is less than a previous first value of the desired objective function.

Example 21. The system of example 20, further including, in response to determining that the current first value of the desired objective function is less than the previous first value of the desired objective function, performing a machine learning process.

Example 22. The system of example 21, where performing the machine learning process includes performing a Bayesian optimization process.

Example 23. The system of example 22, where the controller is further configured to: in response to determining that the desired objective function is greater than the threshold: select a second pulsing template of a second complexity greater than the first complexity; iteratively update values of second pulsing parameters corresponding to the second pulsing template until no further reduction of desired objective function is achieved; and in response to determining that the value of the desired objective function is less than or equal to the threshold: identify updated values of the second pulsing parameters as the best values of the second pulsing parameters.

Example 24. The system of example 23, where iteratively updating the values of the second pulsing parameters includes: performing a third simulation with the values of the second pulsing parameters using the plasma/sheath model to determine second plasma parameters; performing a fourth simulation with the second plasma parameters using the feature model to determine one or more second process features; determining a current second value of the desired objective function based on the one or more second process features; and determining whether the current second value of the desired objective function is less than a previous second value of the desired objective function.

Example 25. A controller including: a non-transitory computer-readable memory configured to store instructions; one or more processors coupled to the non-transitory computer-readable memory, where the instructions, when executed by the one or more processors, cause the one or more processors to: determine process parameters of a plasma process based on a desired objective function; determine a pulsing scheme of the plasma process based on the desired objective function, where the pulsing scheme includes a pulsing petameter matrix including timing and power-level parameters of a radio frequency (RF) source power supply and a bias power supply; send the process parameters and the pulsing scheme to a plasma apparatus; send a first control signal to the plasma apparatus to introduce a substrate into a process chamber of the plasma apparatus; and send a second control signal to the plasma apparatus to perform the plasma process on the substrate using the process parameters and the pulsing scheme.

Example 26. The controller of example 25, where determining the process parameters includes: iteratively updating values of the process parameters until no further reduction of the desired objective function is achieved; and in response to determining that the desired objective function is greater than a threshold: identifying updated values of the process parameters as the best values of the process parameters; and proceeding with the determining the pulsing scheme.

Example 27. The controller of example 26, where the instructions, when executed by the one or more processors, further cause the one or more processors to: in response to determining that the desired objective function is less than or equal to the threshold: identify the updated values of the process parameters as the best values of the process parameters; and skip the determining the pulsing scheme.

Example 28. The controller of any of examples 26 and 27, where iteratively updating the values of the process parameters includes: performing a first simulation with the values of the process parameters using a plasma/sheath model to determine plasma parameters; performing a second simulation with the plasma parameters using a feature model to determine one or more process features; determining a current value of the desired objective function based on the one or more process features; and determining whether the current value of the desired objective function is less than a previous value of the desired objective function.

Example 29. The controller of example 28, further including, in response to determining that the current value of the desired objective function is less than the previous value of the desired objective function, performing a machine learning process.

Example 30. The controller of example 29, where performing the machine learning process includes performing a Bayesian optimization process.

Example 31. The controller of any of examples 25 to 30, where determining the pulsing scheme includes: selecting a first pulsing template of a first complexity; iteratively updating values of first pulsing parameters corresponding to the first pulsing template until no further reduction of the desired objective function is achieved; and in response to determining that the desired objective function is less than or equal to a threshold: identifying updated values of the first pulsing parameters as the best values of the first pulsing parameters.

Example 32. The controller of example 31, where iteratively updating the values of the first pulsing parameters includes: performing a first simulation with the values of the first pulsing parameters using a plasma/sheath model to determine first plasma parameters; performing a second simulation with the first plasma parameters using a feature model to determine one or more first process features; determining a current first value of the desired objective function based on the one or more first process features; and determining whether the current first value of the desired objective function is less than a previous first value of the desired objective function.

Example 33. The controller of example 32, further including, in response to determining that the current first value of the desired objective function is less than the previous first value of the desired objective function, performing a machine learning process.

Example 34. The controller of example 33, where performing the machine learning process includes performing a Bayesian optimization process.

Example 35. The controller of example 34, where the instructions, when executed by the one or more processors, further cause the one or more processors to: in response to determining that the desired objective function is greater than the threshold: selecting a second pulsing template of a second complexity greater than the first complexity; iteratively updating values of second pulsing parameters corresponding to the second pulsing template until no further reduction of desired objective function is achieved; and in response to determining that the value of the desired objective function is less than or equal to the threshold: identifying updated values of the second pulsing parameters as the best values of the second pulsing parameters.

Example 36. The controller of example 35, where iteratively updating the values of the second pulsing parameters includes: performing a third simulation with the values of the second pulsing parameters using the plasma/sheath model to determine second plasma parameters; performing a fourth simulation with the second plasma parameters using the feature model to determine one or more second process features; determining a current second value of the desired objective function based on the one or more second process features; and determining whether the current second value of the desired objective function is less than a previous second value of the desired objective function.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

“Substrate,” “target substrate,” “structure,” or “device” as used herein generically refers to an object being processed in accordance with the disclosure, and may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate, structure, or device is not limited to any particular base structure, underlying layer or overlying layer, patterned or un-patterned, but rather, is contemplated to include any such layer or base structure, and any combination of layers and/or base structures. The description may reference particular types of substrates, structures, or devices, but this is for illustrative purposes only.

Although this disclosure describes particular process steps as occurring in a particular order, this disclosure contemplates the process steps occurring in any suitable order. While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
determining process parameters of a plasma process based on a desired objective function;
determining a pulsing scheme of the plasma process based on the desired objective function, wherein the pulsing scheme comprises a pulsing petameter matrix comprising timing and power-level parameters of a radio frequency (RF) source power supply and a bias power supply;
sending the process parameters and the pulsing scheme to a plasma apparatus;
introducing a substrate into a process chamber of the plasma apparatus; and
performing the plasma process on the substrate using the process parameters and the pulsing scheme.

2. The method of claim 1, wherein determining the pulsing scheme comprises:
selecting a first pulsing template of a first complexity;
iteratively updating values of first pulsing parameters corresponding to the first pulsing template until no further reduction of the desired objective function is achieved; and
in response to determining that the desired objective function is less than or equal to a threshold:
identifying updated values of the first pulsing parameters as the best values of the first pulsing parameters.

3. The method of claim 2, wherein iteratively updating the values of the first pulsing parameters comprises:
performing a first simulation with the values of the first pulsing parameters using a plasma/sheath model to determine first plasma parameters;
performing a second simulation with the first plasma parameters using a feature model to determine one or more first process features;
determining a current first value of the desired objective function based on the one or more first process features; and
determining whether the current first value of the desired objective function is less than a previous first value of the desired objective function.

4. The method of claim 3, further comprising, in response to determining that the current first value of the desired objective function is less than the previous first value of the desired objective function, performing a machine learning process.

5. The method of claim 4, wherein performing the machine learning process comprises performing a Bayesian optimization process.

6. The method of claim 5, further comprising:
in response to determining that the desired objective function is greater than the threshold:
selecting a second pulsing template of a second complexity greater than the first complexity;
iteratively updating values of second pulsing parameters corresponding to the second pulsing template until no further reduction of desired objective function is achieved; and
in response to determining that the value of the desired objective function is less than or equal to the threshold:
identifying updated values of the second pulsing parameters as the best values of the second pulsing parameters.

7. The method of claim 6, wherein iteratively updating the values of the second pulsing parameters comprises:
performing a third simulation with the values of the second pulsing parameters using the plasma/sheath model to determine second plasma parameters;
performing a fourth simulation with the second plasma parameters using the feature model to determine one or more second process features;
determining a current second value of the desired objective function based on the one or more second process features; and
determining whether the current second value of the desired objective function is less than a previous second value of the desired objective function.

8. A system comprising:
a plasma apparatus configured to:
receive a substrate in a process chamber;
receive process parameters and a pulsing scheme for a plasma process from a controller;
perform the plasma process on the substrate using the process parameters and the pulsing scheme; and
the controller coupled to the plasma apparatus, wherein the controller is configured to:
determine the process parameters of the plasma process based on a desired objective function;
determine the pulsing scheme of the plasma process based on the desired objective function, wherein the pulsing scheme comprises a pulsing petameter matrix comprising timing and power-level parameters of a radio frequency (RF) source power supply and a bias power supply; and
send the process parameters and the pulsing scheme to the plasma apparatus.

9. The system of claim 8, wherein determining the pulsing scheme comprises:
selecting a first pulsing template of a first complexity;
iteratively updating values of first pulsing parameters corresponding to the first pulsing template until no further reduction of the desired objective function is achieved; and
in response to determining that the desired objective function is less than or equal to a threshold:
identifying updated values of the first pulsing parameters as the best values of the first pulsing parameters.

10. The system of claim 9, wherein iteratively updating the values of the first pulsing parameters comprises:
performing a first simulation with the values of the first pulsing parameters using a plasma/sheath model to determine first plasma parameters;
performing a second simulation with the first plasma parameters using a feature model to determine one or more first process features;
determining a current first value of the desired objective function based on the one or more first process features; and
determining whether the current first value of the desired objective function is less than a previous first value of the desired objective function.

11. The system of claim 10, further comprising, in response to determining that the current first value of the desired objective function is less than the previous first value of the desired objective function, performing a machine learning process.

12. The system of claim 11, wherein performing the machine learning process comprises performing a Bayesian optimization process.

13. The system of claim 12, wherein the controller is further configured to:
in response to determining that the desired objective function is greater than the threshold:
select a second pulsing template of a second complexity greater than the first complexity;
iteratively update values of second pulsing parameters corresponding to the second pulsing template until no further reduction of desired objective function is achieved; and
in response to determining that the value of the desired objective function is less than or equal to the threshold:
identify updated values of the second pulsing parameters as the best values of the second pulsing parameters.

14. The system of claim 13, wherein iteratively updating the values of the second pulsing parameters comprises:
performing a third simulation with the values of the second pulsing parameters using the plasma/sheath model to determine second plasma parameters;
performing a fourth simulation with the second plasma parameters using the feature model to determine one or more second process features;
determining a current second value of the desired objective function based on the one or more second process features; and
determining whether the current second value of the desired objective function is less than a previous second value of the desired objective function.

15. A controller comprising:
a non-transitory computer-readable memory configured to store instructions;
one or more processors coupled to the non-transitory computer-readable memory, wherein the instructions, when executed by the one or more processors, cause the one or more processors to:
determine process parameters of a plasma process based on a desired objective function;
determine a pulsing scheme of the plasma process based on the desired objective function, wherein the pulsing scheme comprises a pulsing petameter matrix comprising timing and power-level parameters of a radio frequency (RF) source power supply and a bias power supply;
send the process parameters and the pulsing scheme to a plasma apparatus;
send a first control signal to the plasma apparatus to introduce a substrate into a process chamber of the plasma apparatus; and
send a second control signal to the plasma apparatus to perform the plasma process on the substrate using the process parameters and the pulsing scheme.

16. The controller of claim 15, wherein determining the pulsing scheme comprises:
selecting a first pulsing template of a first complexity;
iteratively updating values of first pulsing parameters corresponding to the first pulsing template until no further reduction of the desired objective function is achieved; and
in response to determining that the desired objective function is less than or equal to a threshold:
identifying updated values of the first pulsing parameters as the best values of the first pulsing parameters.

17. The controller of claim 16, wherein iteratively updating the values of the first pulsing parameters comprises:
performing a first simulation with the values of the first pulsing parameters using a plasma/sheath model to determine first plasma parameters;
performing a second simulation with the first plasma parameters using a feature model to determine one or more first process features;
determining a current first value of the desired objective function based on the one or more first process features; and
determining whether the current first value of the desired objective function is less than a previous first value of the desired objective function.

18. The controller of claim 17, further comprising, in response to determining that the current first value of the desired objective function is less than the previous first value of the desired objective function, performing a machine learning process.

19. The controller of claim 18, wherein the instructions, when executed by the one or more processors, further cause the one or more processors to:
in response to determining that the desired objective function is greater than the threshold:
selecting a second pulsing template of a second complexity greater than the first complexity;
iteratively updating values of second pulsing parameters corresponding to the second pulsing template until no further reduction of desired objective function is achieved; and
in response to determining that the value of the desired objective function is less than or equal to the threshold:
identifying updated values of the second pulsing parameters as the best values of the second pulsing parameters.

20. The controller of claim 19, wherein iteratively updating the values of the second pulsing parameters comprises:
performing a third simulation with the values of the second pulsing parameters using the plasma/sheath model to determine second plasma parameters;
performing a fourth simulation with the second plasma parameters using the feature model to determine one or more second process features;
determining a current second value of the desired objective function based on the one or more second process features; and
determining whether the current second value of the desired objective function is less than a previous second value of the desired objective function.
